(19) United States
(12) Patent Application Publication
(10) Pub. No.: US 2026/0249992 A1
(43) Pub. Date: Aug. 27, 2026

(54) Load Stability Systems and Methods

(71) Applicants: VIRGINIA TECH INTELLECTUAL PROPERTIES, INC., Blacksburg, VA (US); University of Rome "La Sapienza", Rome (IT)

(72) Inventors: Mary Yvonne LANZEROTTI, Blacksburg, VA (US); Luyi TANG, Pittsburgh, PA (US); Walter LACARBONARA, Rome (IT); Kyle NGUYEN, Fairfax, VA (US); Rui PENG, Blacksburg, VA (US); David Raymond REINEKE, Saint Charles, MO (US)

(21) Appl. No.: 19/005,445

(22) Filed: Dec. 30, 2024

Related U.S. Application Data
(60) Provisional application No. 63/615,497, filed on Dec. 28, 2023.

(51) Int. Cl. B64D 1/22; B64C 17/00; B64C 27/04; B66D 1/48; B66D 1/54

(52) U.S. Cl. CPC B64D 1/22; B64C 17/00; B64C 27/04; B66D 1/485; B66D 1/54

(57) ABSTRACT

Load stabilization systems and methods are described. In one example, a load stabilization system includes a hoist system with a hoist cable, an inertial measurement and control unit located with a payload of the hoist system, and a hoist controller. The hoist controller includes a communications module configured to receive data from the inertial measurement and control unit, and a processor configured to direct the hoist system to reel in the hoist cable during at least one period of time based on the data from the inertial measurement and control unit. In some cases, the processor is further configured, based on the data from the inertial measurement and control unit, to reel in the hoist cable during a first period of time and to not reel up the hoist cable during a second period of time, and to reel out the hoist cable during a third period of time.

### CROSS-REFERENCE TO RELATED APPLICATIONS

This application claims the benefit of and priority to U.S. Provisional Application No. 63/615,497, filed Dec. 28, 2023 (“the '497 Application”), the entire contents of which is hereby incorporated herein by reference.

### BACKGROUND

Helicopter payloads for medical evacuation (MEDEVAC) rescues, among other types of payloads, can be difficult to stabilize once the payload begins to swing. As a result of oscillation motion during reel in and reel out, the payload can begin to swing in three dimensions under the helicopter. Swinging can pose a threat to the helicopter, ground crew, the pilot and crew in the helicopter, and the medical personnel and payload attached to the hoist cable.

### BRIEF DESCRIPTION OF THE DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1 illustrates an example helicopter with a hoist system and a hoist control system according to various examples described herein.

FIG. 2 illustrates components of the hoist system and the hoist control system shown in FIG. 1 according to various examples described herein.

FIG. 3A illustrates an example trajectory of a payload shown in FIG. 2 according to various examples described herein.

FIG. 3B illustrates another example trajectory of a payload shown in FIG. 2 according to various examples described herein.

FIG. 3C illustrates another example trajectory of a payload shown in FIG. 2 according to various examples described herein.

FIG. 4 illustrates an example hoist control method according to various examples described herein.

### DETAILED DESCRIPTION

As noted above, it can be difficult to decrease the amplitude of oscillations of swinging helicopter payloads, among other types of payloads, for medical evacuation (MEDEVAC) rescues and other related maneuvers, once the payload begins to swing. As a result of motion during lifting (reel in) and lengthening (reel out) and external forces such as wind and rotorwash, the payload can begin to swing or increase swinging of existing oscillations in three dimensions under the helicopter. Swinging can pose a threat to the helicopter, ground crew, the pilot and crew in the helicopter, and the medical personnel and payload attached to the hoist cable. Medical evacuation rescues are also time-sensitive, and the capability to decrease the amplitude of oscillations of a payload can help the medical evacuation team to achieve faster rescue times and successful patient outcomes.

In that context, a number of load stability systems and methods are described. In one example, a load stabilization system includes a hoist system with a hoist cable, an inertial measurement and control unit located with a payload of the hoist system, and a hoist controller. The hoist controller includes a communications module configured to receive data from the inertial measurement and control unit, and a processor configured to direct the hoist system to reel up or reel in the hoist cable during at least one period of time based on the data from the inertial measurement and control unit. In some cases, the processor is further configured, based on the data from the inertial measurement and control unit, to reel up the hoist cable during a first period of time and to not reel up the hoist cable during a second period of time. The processor can also be configured to reel out the cable during a third period of time. The selection or sequence of reel in, neither reel in nor reel out but constant length, and reel out can be accomplished in any sequence and time intervals including but not limited to solely reel in at the ends of the swing and neither reel in nor reel out during the rest of the swing. Other examples are described below.

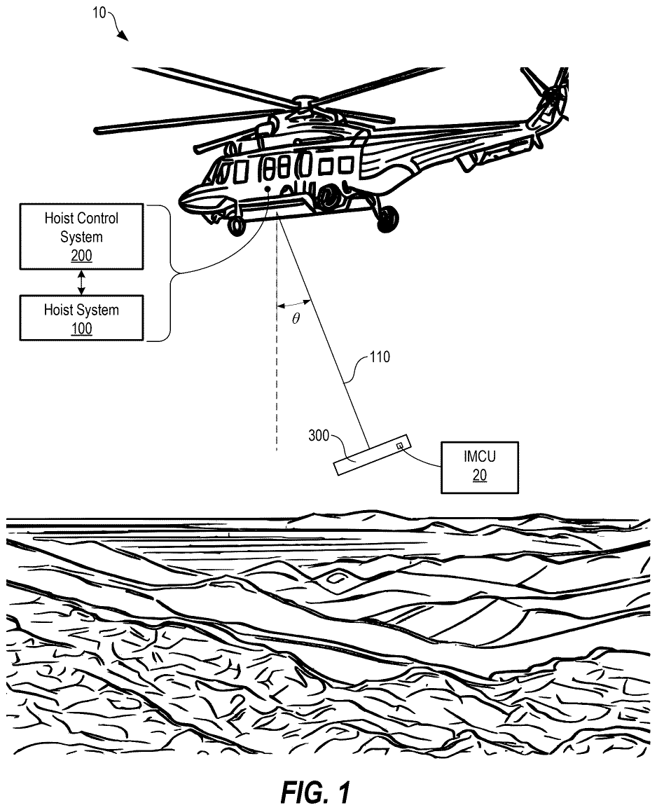

Turning to the drawings, FIG. 1 illustrates an example helicopter 10 with a hoist system 100 and a hoist control system 200 according to various examples described herein. The helicopter 10 is illustrated as a representative example of a helicopter suitable for MEDEVAC rescues. The helicopter 10 includes the hoist system 100 and the hoist control system 200 to facilitate MEDEVAC rescues in the examples described herein, and both the hoist system 100 and the hoist control system 200 are described in further detail below. The hoist system 100 and the hoist control system 200 are not limited to use with any particular type of airborne vehicle. The hoist system 100 and the hoist control system 200, as described herein, can be incorporated into other systems, such as a range of different types of helicopters, air ballons, drones, airplanes, airborne vehicles, cranes, and other maneuvering and lifting systems for a range of applications. In some cases, the hoist control system 200, or one or more components of the hoist control system 200, can also be positioned with the payload 300 as described below. Additionally, in some cases, the processing and control aspects of the hoist control system 200, as described herein, can be performed in part or in whole by the inertial measurement and control unit 20 (“IMCU 20”).

Among other components described below, the hoist system 100 includes a hoist cable 110 with a payload 300 attached at one end of the hoist cable 110. The payload 300 can include a range of different payloads, and the hoist system 100 is configured to both lower (reel out) (i.e., increase the cable length to lower the payload further away from the helicopter) and retract (reel in) (i.e., decrease the cable length to raise the payload closer to the helicopter) the hoist cable 110 and the payload 300. In the context of MEDEVAC rescues, the payload 300 can be a person or individual in need of medical attention or other care, although the payload 300 can be anything with mass inertia at the end of the hoist cable 110. However, the payload 300 does not need to be a person or individual. The payload 300 can also be representative of a package or other type of payload. The hoist system 100 can include a motor, gearbox, and related components capable of lowering and retracting the hoist cable 110 and the payload 300 at the end of the hoist cable 110.

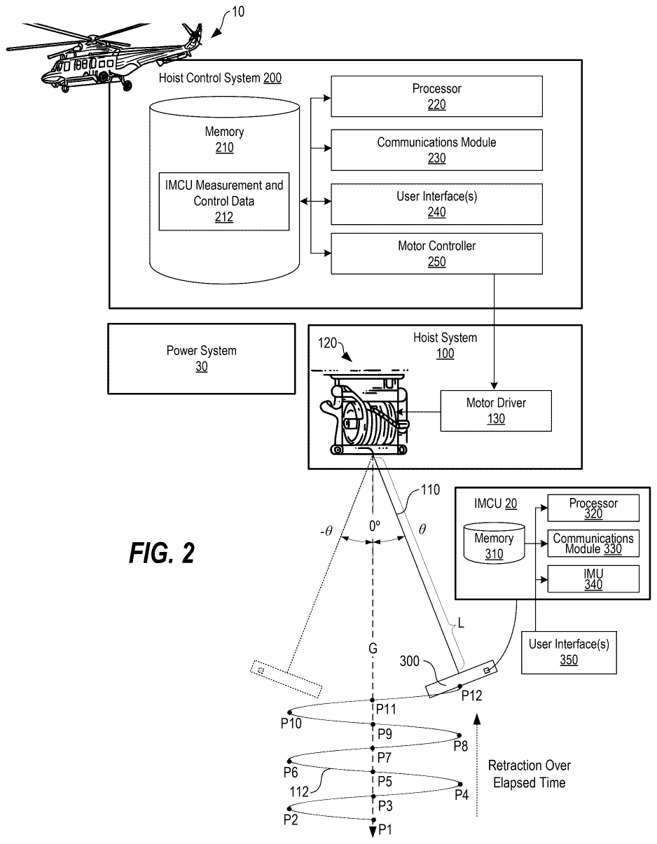

In the example shown in FIG. 1, the IMCU 20 is positioned with the payload 300 at the end of the hoist cable 110. The IMCU 20, which is also described in further detail below with reference to FIG. 2, can be embodied as or include one or more memories, processors, inertial measurement units, batteries or power systems, and other components. The IMCU 20 can also include a power system separate from the power system 30, such as one or more batteries or other suitable power supplies. The inertial measurement unit of the IMCU 20 can include one or more accelerometers, gyroscopes, magnetometers, and/or other types of sensors capable of measuring orientation, velocity, acceleration, triaxial measurement data, and other measurement data related to the motion and spatial location of the payload 300. The IMCU 20 can provide triaxial measurement data related to the velocity, acceleration, triaxial motion, and other measurement data related to the payload 300 to the hoist control system 200 by wireless or wired communications, as described in further detail below. In another example, the IMCU 20 can be positioned at other locations, such as at or toward a distal end of the hoist cable 110, at other locations at or on the payload 300, and at other locations. The IMCU 20 can also include other components, such as one or more power sources, batteries, etc., memory and processing circuitry, and physical layer communications interfaces for wired or wireless data communications with the communications module 230 of the hoist control system 200.

Helicopter payloads, such as the payload 300, can be difficult to stabilize during MEDEVAC rescues and other related maneuvers. The payload 300 is a payload of the helicopter 10 and can behave as a type of pendulum at the end of the hoist cable 110. Due to movement of the helicopter 10, the rotor downwash from the helicopter 10, wind, and other factors, the payload 300 can oscillate and swing to some extent under the helicopter 10. The payload 300 can even oscillate and swing when the helicopter is attempting to hover in one location. Swinging can pose a threat to the helicopter 10, the ground crew, the pilot and crew in the helicopter 10, the medical personnel and payload 300 attached to the hoist cable 110, and others. In FIG. 1, the angle θ is referred to as the swing angle. Under relatively ideal conditions, the value of the swing angle θ should be maintained to under a certain predetermined or prespecified value or values, such as less than 5 degrees, which is an example of a desired target for a medical evacuation rescue. In practice, however, the swing angle θ can often increase to much larger angles, such as over 10 degrees, over 15 degrees, or more, and excessive angles can lead to dangerous conditions, loss of the payload 300, and other undesirable outcomes.

According to aspects of the embodiments described herein, the hoist control system 200 is configured to receive control data from the IMCU 20. The control data from the IMCU 20 can be embodied in any suitable format and can include command and control signals, user control data, inertial measurement data, and other types of data in any suitable format. The inertial measurement data can include triaxial measurement data, including but not limited to spatial position, velocity, acceleration, pitch, yaw, roll, time rate of change of pitch, time rate of change of yaw, time rate of change of roll, and other data. The inertial measurement data is captured and, in some cases, processed by the IMCU 20 before it is communicated to the hoist control system 200. The triaxial measurement data is related to the three-dimensional motion of the payload 300 over time.

The embodiments described herein achieve load stabilization of the payload 300 based on one or more load stabilization control algorithms, operating based on feedback in at least some cases, that directs or controls the length “L” of the hoist cable 110 over time. Through control of the length of the hoist cable 110, the maximum positive swing angle θ and the maximum negative swing angle −θ can be reduced over time. Thus, the swing angle can be reduced over time by a directed and controlled change in the length L of the hoist cable 110, by sequences of reeling in and reeling out the hoist cable 110 in a controlled manner in a variety of combinations over time.

Among the embodiments, the hoist control system 200, the IMCU 20, or a combination of the hoist control system 200 and the IMCU 20, can direct whether and when (and to what extent or speed) to reel in or to retract the hoist cable 110 as part of a load stabilization control algorithm. The hoist control system 200, the IMCU 20, or a combination of the hoist control system 200 and the IMCU 20, can also direct whether and when (and to what extent or speed) to reel out or to extend the hoist cable 110. The hoist control system 200, the IMCU 20, or a combination of the hoist control system 200 and the IMCU 20 can also decide whether and when to maintain a constant length of the hoist cable 110 (i.e., neither reeling in nor reeling out).

In one case, the hoist control system 200 is configured to direct the hoist system 100 to reel in, to reel out, and to maintain the length of the hoist cable 110 as part of the load stabilization control algorithm. The hoist control system 200 can control the hoist system 100 based on the triaxial measurement data received from the IMCU 20. In another case, the IMCU 20 is configured to send command signals to the hoist control system 200, and the command signals direct the hoist system 100 to reel in, to reel out, and to maintain the length of the hoist cable 110 as part of the load stabilization control algorithm.

The hoist control system 200, the IMCU 20, or a combination of the hoist control system 200 and the IMCU 20 can decide whether to issue a “T” or “F” signal, for example, to direct the hoist system 100 to vary the length of the hoist cable 110 at or during one or more times based on the triaxial measurement data, which can be gathered over time. By varying the length of the hoist cable 110 at certain times based on the triaxial measurement data of the payload 300, the hoist control system 200, the IMCU 20, or both can help to stabilize the amplitude of oscillation of the payload 300 as the payload 300 is being reeled in and reeled out. To achieve a “net” reduction in the length of the hoist cable 110 extending below the helicopter 10, the hoist system 100 can be controlled to reel in to a greater extent than reel out. Particularly, the hoist control system 200 can help to reduce the swing angle θ or maintain the swing angle θ within a suitable range, such as below 15 degrees, below 10 degrees, or below 5 degrees or less, which is the target desired for a medical evacuation rescue as specified by crew chiefs and medical evacuation rescue helicopter pilots. Aspects of the embodiments also allow for an automated stabilization system that can be enabled and disabled with the toggle of a switch to help stabilize the movement of the payload 300 under certain conditions.

FIG. 2 illustrates additional components of the hoist system 100, the hoist control system 200, and the IMCU 20 shown in FIG. 1 according to various examples described herein. The hoist system 100 includes a hoist and winch 120 and a motor driver 130, among possibly other components. The hoist control system 200 includes a memory 210, a processor 220, a communications module 230, user interface(s) 240, and a motor controller 250, among possibly other components. The hoist control system 200 also includes one or more local interfaces (e.g., one or more serial or parallel buses, etc.) between the memory 210, the processor 220, the communications module 230, the user interfaces 240, and the motor controller 250 for data communications between them. The memory 210 can store a range of data, such as inertial measurement and control data from the IMCU 20, computer-readable instructions or software for execution by the processor 220, and other data. FIG. 2 also illustrates a power system 30, which can be embodied as any suitable power supply or power system for the hoist control system 100, the hoist control system 200, and possibly other components. The power system 30 can also be embodied as two or more separate power systems in some cases.

As an example, the hoist control system 200 can be embodied as an embedded single-board microcontroller processing system, such as a Raspberry Pi, Arduino, or related single-board microcontroller. The hoist control system 200 can also be embodied as a programmable logic controller (PLC) or related control system. The hoist control system 200, however, is not limited to any type or style of controller, microcontroller system, or microcontroller processing system. The hoist control system 200 is configured to receive and store data, such as the triaxial measurement data received from the IMCU 20, command and control signals received from the IMCU 20, and other data. The hoist control system 200 is also configured to execute computer-readable instructions or code (i.e., software) to direct the operation of the hoist control system 200 and the hoist system 100.

The processor 220 can be embodied as one or more general purpose processors, application specific integrated circuits (ASICs), programmable logic devices (e.g., field-programmable gate array (FPGAs), complex programmable logic devices (CPLDs)), or other processing circuitry. The processor 220 can execute software or computer-readable instructions stored on the memory 210 in some cases. As one example, the processor 220 can be embodied as a microcontroller on a printed circuit board. The circuit board can include a local interface for data communications between the memory 210, the processor 220, the communications module 230, the user interfaces 240, and the motor controller 250.

The processor 220 can interface with the memory 210, the processor 220, the communications module 230, the user interfaces 240, and the motor controller 250 to direct the operations of those components. For example, the processor 220 can interface with the communications module 230 to receive triaxial measurement data from the IMCU 20, receive command and control signals from the IMCU 20, and receive other data from the IMCU 20 at one or more times or over intervals of time. The processor 220 can also collect and store the data from the IMCU 20 in the memory 210 as the IMCU measurement and control data 212. Additionally, the processor 220 can process the IMCU measurement and control data 212 and direct the motor controller 250 based on the data. The processor 220 can also receive user-based instructions or feedback over the user interface 240, which is described in further detail below.

The memory 210 can be embodied as one or more memory devices capable of storing data for the hoist control system 200. The memory 210 can store data, such as software or computer-readable instructions, for execution by the processor 220. The memory 210 can also store data gathered by the IMCU 20, as well as data obtained from other sensors in the hoist control system 200, in the hoist system 100, and in the helicopter 10, as the data is gathered over time.

The communications module 230 can include one or more physical layer communications interfaces for wireless data communications, such as WiFi®, Bluetooth®, ZigBee®, and other wireless data interfaces. The communications module 230 can also include one or more physical layer communications interfaces for wired data communications. Thus, the communications module 230 can receive data from and transmit data to the IMCU 20. As one example, the communications module 230 can receive triaxial measurement data from the IMCU 20. The triaxial measurement data can include triaxial measurement information (e.g., position, velocity, acceleration, etc.) related to the motion of the payload 300 over time. As another example, the communications module 230 can receive command and control signals from the IMCU 20.

The user interfaces 240 (also “user interface 240”) can be embodied as one or more user interfaces, such as one or more display screens, one or more input devices (e.g., buttons, keyboards, joysticks, handheld controllers, etc.), tactile or haptic interfaces, and/or other interfaces for use by an individual. The user interfaces 240 are not limited to any particular type or style of input device, however, and a range of different input devices and interfaces can be relied upon.

The user interface 240 can be relied upon to control the overall operation of the hoist system 100 and the hoist control system 200. As one example, the user interface 240 can include one or more physical buttons to direct the following control modes: (1) manual extension, (2) manual retraction, (3) stabilized extension, and (4) stabilized retraction. As another example, the user interface 240 can include one or more buttons to direct either manual or stabilized modes. The main difference between the “manual” and “stabilized” modes of operation is that, during the “stabilized” modes, the hoist control system 200 is configured to automatically reduce the swing angle θ during extension of the hoist cable 110, during retraction of the hoist cable 110, or during both extension and retraction of the hoist cable 110.

During the “manual” modes, the hoist control system 200 is configured to extend or retract the hoist cable 110 without directly measuring or accounting for the swing angle θ. In one sense, the manual modes are “open loop” and do not account for the inertial, triaxial, spatial, and related measurement information received from the IMCU 20. The automatic modes are “closed loop” and account for the measurement information received from the IMCU 20.

In some cases, the manual and automatic modes of operation of the hoist system 100 and the hoist control system 200 can be controlled by a single button or toggle switch of the user interface 240. Thus, aspects of the embodiments allow for an automated stabilization system that can be enabled and disabled in a simple, effective, and user-friendly way that preserves “agency” for the crew chiefs on the helicopter 10. The extension and retraction modes of operation can also be controlled by one or more buttons or toggle switches of the user interface 240. The user interface 240 can also include one or more physical buttons, dials, or inputs to control the speed of the extension or the speed of the retraction of the hoist cable 110.

The user interface 240 is not limited to any type or combination of buttons, dials, knobs, or other input mechanisms. The user interface can be implemented and embodied in any suitable format, including using joysticks, trackballs, wheels, touchscreens, and other input mechanisms. The feedback obtained from use of the user interface 240 is referred to as user control data.

The power system 30 can be embodied as any suitable power source, power supply, or power storage or generation device. As examples, the power system 30 can be embodied as one or more batteries, power converters, electric generators, solar panels, or combinations thereof. The power system 30 can provide power to the hoist system 100, the hoist control system 200, or both. The power system 30 can also supply power to one or more other systems of the helicopter 10 in some cases. The helicopter 10 can also include onboard systems for the generation of power, and the power system 30 can be embodied as part of the onboard systems of the helicopter 10 for the generation of power.

The hoist control system 200 is configured to receive, monitor, and process the command and control signals, inertial measurement data, triaxial measurement data (e.g., the position, velocity, acceleration, triaxial measurement data, pitch, yaw, roll, rate of change of pitch, rate of change of yaw, rate of change of roll, et cetera), and any other data received from the IMCU 20. The command and control signals, inertial measurement data, and triaxial measurement data received by the hoist control system 200 from the IMCU 20 is also collectively referenced herein as control data from the IMCU 20. The hoist control system 200 is also configured to direct the hoist system 100 to vary the length of the hoist cable 110 at or during one or more times based on the control data from the IMCU 20. By varying the length of the hoist cable 110 at certain times, the hoist control system 200 can help to stabilize the movement (e.g., sway) of the payload 300 as the payload 300 is being retracted towards the helicopter 10. Particularly, the hoist control system 200 can help to reduce the swing angle θ or maintain the swing angle θ within a suitable range, such as below 15 degrees, below 10 degrees, or below 5 degrees or less, which can be a desired target for a medical evacuation rescue as specified by crew chiefs and medical evacuation rescue helicopter pilots.

Referring to FIG. 2 as an example, the payload 300 is representatively illustrated to swing as it is being retracted toward the helicopter 10 over time. The representative swing in FIG. 2 (and the related figures) does not illustrate decreasing amplitude of the swing over time, but decreasing amplitude of the swing can be achieved by the embodiments. The payload 300 is attached at one end of the hoist cable 110. The hoist and winch 120 can be directed to retract (e.g., reel in) the hoist cable 110 based on a control signal provided from the motor controller 250, as directed by an operator of the hoist control system 200 using the user interfaces 240. During retraction, the total or overall length “L” of the hoist cable 110 will be reduced as the winch 120 rotates or winds up the hoist cable 110.

The payload 300 attached to the hoist cable 110 may also swing from side to side during the retraction. As shown in the example of FIG. 2, as compared to the downward direction of gravitational force “G” (where θ=zero) experienced by the helicopter 10 and the payload 300, the payload 300 attached to the hoist cable 110 swings from side to side reaching a maximum positive swing angle θ and a maximum negative swing angle −θ. Over time during swinging, the hoist cable 110 will repeatedly oscillate between the maximum positive swing angle θ and a maximum negative swing angle −θ, passing through the vertical. The value of θ and −θ can vary over time, and the magnitude of theta (θ) can vary over time, particularly as the length L of the hoist cable 110 changes, while reeling in or reeling out. Additionally, the speed of the swing of the payload or velocity of the swing of the payload 300 can also vary over time as the length L of the hoist cable 110 changes, while reeling in, reeling out, or a combination of sequences of reeling in, reeling out, and periods of constant length (neither reeling in nor reeling out).

As shown in FIG. 2, the IMCU 20 includes a memory 310, a processor 320, a communications module 330, and an inertial measurement unit 340, among possibly other components. The IMCU 20 also includes a user interface 350. The IMCU 20 can also include batteries, power systems, and other components. The IMCU 20 also includes one or more local interfaces (e.g., one or more serial or parallel buses, etc.) between the memory 310, the processor 320, the communications module 330, the inertial measurement unit 340, the user interface 350, and possibly other components for data communications between them. The memory 310 can store a range of data, such as data collected by the inertial measurement unit 340 and computer-readable instructions or software for execution by the processor 320.

As an example, the IMCU 20 can be embodied as an embedded single-board microcontroller processing system, such as a Raspberry Pi, Arduino, or related single-board microcontroller. The IMCU 20 can also be embodied as a PLC or related control system. The IMCU 20 is not limited to any type or style of controller or microcontroller system. The IMCU 20 is also configured to execute computer-readable instructions or code (i.e., software) to direct the operation of the IMCU 20.

The processor 320 can be embodied as one or more general purpose processors, ASICs, programmable logic devices, or other processing circuitry. The processor 320 can execute software or computer-readable instructions stored on the memory 310 in some cases. As one example, the processor 320 can be embodied as a microcontroller on a printed circuit board. The circuit board can include a local interface for data communications between the memory 310, the processor 320, the communications module 330, the inertial measurement unit 340, the user interface 350, and possibly other components.

The memory 310 can be embodied as one or more memory devices capable of storing data for the IMCU 20. The memory 310 can store data, such as software or computer-readable instructions, for execution by the processor 320. The memory 310 can also store data gathered by the inertial measurement unit 340. In some cases, the memory 310 can also store data received from the hoist system 100, the hoist control system 200, the helicopter 10, sensors in the helicopter 10, and other data gathered over time.

The communications module 330 can include one or more physical layer communications interfaces for wireless data communications, such as WiFi®, Bluetooth®, ZigBee®, and other wireless data interfaces. The communications module 330 can also include one or more physical layer communications interfaces for wired data communications. Thus, the communications module 330 can receive data from and transmit data to the communications module 230 of the hoist control system 200. As examples, the communications module 330 can receive and transmit command and control signals, inertial measurement data, triaxial measurement data, and related control data to and from the hoist control system 200. The triaxial measurement data can include triaxial measurement information (e.g., position, velocity, acceleration, etc.) related to the motion of the payload 300 over time.

The inertial measurement unit 340 (“IMU 340”) can be embodied as one or more inertial measurements units. The inertial measurements units can be placed or positioned at any suitable position or positions at, on, or around the payload 300 or toward a distal end of the hoist cable 110. The IMU 340 can include one or more accelerometers, gyroscopes, magnetometers, and other types of sensors capable of measuring orientation, velocity, acceleration, triaxial measurement data, and other measurement data related to the motion and spatial location of the payload 300. The hoist control system 200 can also include an inertial measurement unit similar to the IMU 340 in some cases. The IMU of the host control system 200 can include one or more accelerometers, gyroscopes, magnetometers, and other types of sensors capable of measuring orientation, velocity, acceleration, triaxial measurement data, and other measurement data related to the motion and spatial location of the helicopter 10.

The user interfaces 350 (also “user interface 350”) can be embodied as one or more user interfaces, such as one or more display screens, one or more input devices (e.g., buttons, keyboards, joysticks, handheld controllers, etc.), tactile or haptic interfaces, and/or other interfaces for use by an individual. In some cases, the user interface 350 can be provided to an individual being rescued as the payload 300. Thus, the embodiments described herein permit a type of “agency” to be afforded to an individual being rescued, because the individual can control certain aspects of the operation of the load stabilization system.

Similar to the user interface 240 described above, the user interface 350 can be relied upon to control the overall operation of the hoist system 100 and the hoist control system 200. As one example, the user interface 350 can include one or more buttons to direct the following control modes: (1) manual extension, (2) manual retraction, (3) stabilized extension, and (4) stabilized retraction. As another example, the user interface 350 can include one or more buttons to direct either manual or stabilized modes. Among the embodiments, the user interface 240, the user interface 350, or a combination of the user interfaces 240 and 350 can direct the operation of the hoist system 100 and the hoist control system 200.

An example trajectory 112 of the distal end of the hoist cable 110 over time is illustrated in FIG. 2. The trajectory 112 is representative of the position of the payload 300 or the distal end of the hoist cable 110 over time, although it does not show a decrease in magnitude of maximum swing angle over time (which is assumed), during retraction of the hoist cable 110. The trajectory 112 is illustrated as a representative example in FIG. 2. It should be appreciated that the payload 300 can swing in three-dimensional space as it is being retracted toward the helicopter 10, although the trajectory 112 is not illustrated to show three-dimensional motion. The trajectory 112 is depicted for the purpose of explaining the concepts of the load stability systems and methods described herein, and it is not intended to be limiting or exhaustive with regard to the types of motion that can be experienced by the payload 300. The swing angles θ described herein are measured between the direction of gravitational force G and the hoist cable 110, in the same plane that intersects with both the downward direction of gravitational force G and a length of the hoist cable 110 (e.g., assuming the hoist cable 110 extends in a straight line with nonzero tension in the cable due to mass attached at the end of the cable). The swing angle θ can vary over time as described herein.

A number of points P1-P12 are shown along the trajectory 112, and each of the points P1-P12 is associated with a different moment in time. The points P1, P3, P5, P7, P9, and P11 intersect with the vertical line along the downward direction of the gravitational force G. Thus, at points P1, P3, P5, P7, P9, and P11, the swing angle θ is at a minimum, is near zero, or is zero. Points P4, P8, and P12 are maximum positive swing angles θ. Points P2, P6, and P10 are maximum negative swing angles −θ. The angles θ at points P4, P8, and P12 can vary as compared to and be different than each other. The angles θ at points P2, P6, and P10 can vary as compared to and be different than each other.

In some cases, when the length L of the hoist cable 110 decreases over time based on retraction, the magnitudes of the maximum positive and negative swing angles θ increases over time, leading to a problematic and possibly dangerous condition for the crew in the helicopter 10, the payload 300, and possibly others. The illustration in FIG. 2 shows a dangerous condition since the angle θ of the cable is too large under the helicopter.

The IMU 340 and IMCU 20 can measure, capture, and store triaxial measurement data related to the velocity, acceleration, pitch, yaw, roll, time rate of change of pitch, time rate of change of yaw, time rate of change of roll, and other triaxial information related to the payload 300 over time as it moves along the trajectory 112. The communications module 330 of the IMCU 20 can also communicate the triaxial measurement data to the hoist control system 200 by wired or wireless communications with the communications module 230. Thus, according to aspects of the embodiments, the IMCU 20 is configured to capture, store, and measure or evaluate triaxial measurement data related to the velocity, acceleration, and other triaxial measurement information at the points P1-P12, among others over time, as the payload 300 extends along the trajectory 112. The IMCU 20 can also process the triaxial measurement data and communicate it to the hoist control system 200.

In some cases, the IMCU 20 is configured to locally process the triaxial measurement data and develop command and control signals based on the triaxial measurement data. The IMCU 20 can then communicate the command and control signals to the hoist control system 200. Examples of command and control signals include the “T” and “F” control signals described below, where “T” is a command to reel in or up the hoist cable 110 and “F” is a command to maintain the length of the hoist cable 110. An example “T” command can include command or control information that specifies a particular retraction or reel in speed to be used, along with a frame or time period over which the speed is to be used. An example “F” command can include command or control information to specify a frame or period of time over which the length of the hoist cable 110 should be maintained (i.e., neither reeled in nor reeled out). Another example “F” command can include command or control information that specifies a particular extension or reel out speed to be used, along with a frame or time period over which the speed is to be used.

The communications module 230 of the hoist control system 200 can receive the triaxial measurement data, the “T” or “F” control signals, and other data from the communications module 330 of the IMCU 20 and store it as the measurement and control data 212 in the memory 210. The processor 220 can reference the measurement and control data 212 as part of a load stabilization control algorithm used to direct the motor controller 250 and the operations of the hoist system 100, as described herein.

As part of the load stabilization control algorithm, the processor 220 can direct the motor controller 150 to retract (i.e., reel in) the hoist cable 110 during at least one period of time based on the data received from the IMCU 20, as the payload oscillates along of the trajectory 112. In some cases, the processor 220 can also direct the motor controller 150 to extend the hoist cable 110 during at least one other period of time based on the data received from the IMCU 20. A number of examples of the operation of the stabilized retraction control algorithm are described below.

The helicopter 10 can be positioned in a steady hover (substantially not moving) above a patient in a medical evacuation rescue. The angular velocity of an object experiencing swinging below the helicopter 10 at some radius, such as the payload 300 at a distance of length L of the hoist cable 110, tends to increase when the object swings back to the center of the swing with zero degrees (angle theta) from either the right or from the left of the center (zero degrees). Thus, the velocity of the payload 300 can be greatest at the points P1, P3, P5, P7, P9, and P11 along the trajectory 112.

In one mode of operation, the IMCU 20 is configured to locally process the triaxial measurement data from the IMU 340 and to generate the “T” or “F” control signals. The IMCU 20 then communicates the “T” or “F” control signals to the hoist control system 200. In turn, the hoist control system 200 directs the hoist system 100 based on the “T” or “F” control signals received from the IMU 340. For example, with reference to the triaxial measurement data, the IMCU 20 is configured to generate a “T” control signal when the velocity of the payload 300 is relatively slow or below a predetermined threshold (i.e., when the angular velocity of the payload 300 is lower). The IMCU 20 is also configured to generate an “F” control signal when the velocity of the payload 300 is relatively fast or above a predetermined threshold. The “T” and “F” control signals can be communicated by the communications module 330 of the IMU 340 to the communications module 230 of the hoist control system 200. The hoist control system 200 can then direct the operation of the hoist system 100 based on the “T” or “F” signals, where is “T” signal is a command to reel in the hoist cable 110 and an “F” signal is a command to maintain the length of the hoist cable 110.

In another mode of operation, the IMCU 20 is configured to generate the “T” control signal when the velocity of the payload 300 is relatively slow and the angle of the payload 300 is higher than some prespecified threshold value. The IMCU 20 is also configured to generate the “F” control signal when the velocity of the payload 300 is relatively fast and the angle of the payload 300 is lower than some prespecified threshold value. The “T” and “F” control signals can be communicated from the IMU 340 to the hoist control system 200. The hoist control system 200 can then direct the operation of the hoist system 100, in turn, based on the “T” or “F” signals.

Thus, the IMCU 20 can issue a “T” control signal to direct the hoist control system 200 to start the retraction of the hoist cable 110 as the velocity of the payload 300 decreases below a prespecified threshold and the angle of the payload 300 increases above a prespecified threshold, such as at point P2 along the trajectory 112 shown in FIG. 2. The IMCU 20 can issue an “F” control signal to direct the hoist control system 200 to stop the retraction of the hoist cable 110 as the velocity of the payload 300 increases above a certain threshold and when the angle of the payload 300 decreases below a prespecified threshold, such as at point P3 along the trajectory 112.

In other modes of operation, the processor 220 of the hoist control system 200 is configured to control the operation of the hoist system 100 based on the triaxial measurement data received from the IMCU 20. For example, with reference to the triaxial measurement data, the hoist control system 200 is configured to retract the hoist cable 110, or to retract the hoist cable 110 more quickly, when the velocity of the payload 300 is relatively slow (i.e., when the angular velocity of the payload 300 is lower). The hoist control system 200 is also configured to either not retract the hoist cable 110, or to retract the hoist cable 110 more slowly, when the velocity of the payload 300 is relatively fast (i.e., when the angular velocity of the payload 300 is higher). Further, in some cases, the hoist control system 200 can be configured to extend the hoist cable 110 when the velocity of the payload 300 is relatively fast. These and other examples are described below. However, the examples are not intended to be limiting, and the concepts described herein can be extended to related control approaches.

Referring still to FIG. 2, the triaxial measurement data captured by the IMCU 20, which includes angular velocity and the angle of the payload 300, changes over time and position along the trajectory 112. For example, the velocity of the payload 300 reduces approaching the points P2, P4, P6, P8, P10, and P12 and may reach zero velocity (or near zero velocity) at those points. On the other hand, the velocity of the payload 300 increases approaching the points P1, P3, P5, P7, P9, and P11 along the trajectory 112.

According to one aspect of the embodiments, the hoist control system 200 can direct the motor controller 150 to increase the retraction of the hoist cable 110, or to retract the hoist cable 110 more quickly, when the velocity of the payload 300 is relatively lower, when the angle is higher than some threshold, or some combination thereof. The hoist control system 200 can also direct the motor controller 150 to decrease the retraction of the hoist cable 110, or to extend the hoist cable 110, when the velocity of the payload 300 is relatively higher, when the angle is lower than some threshold, or some combination thereof.

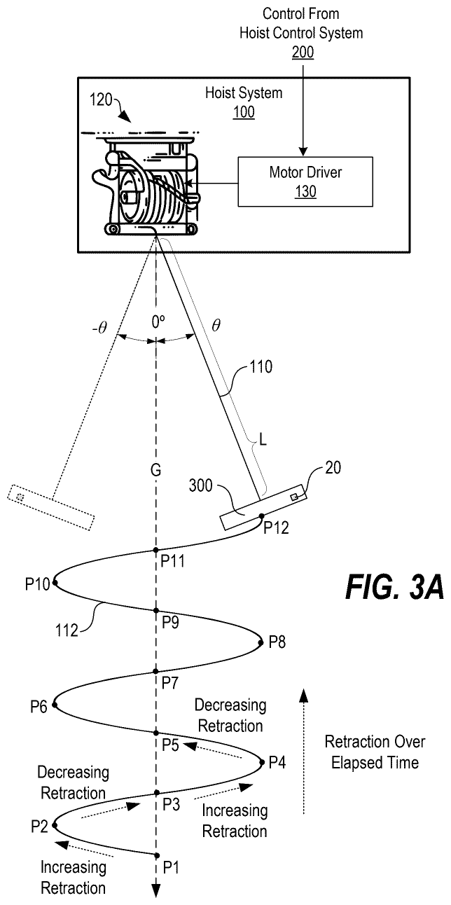

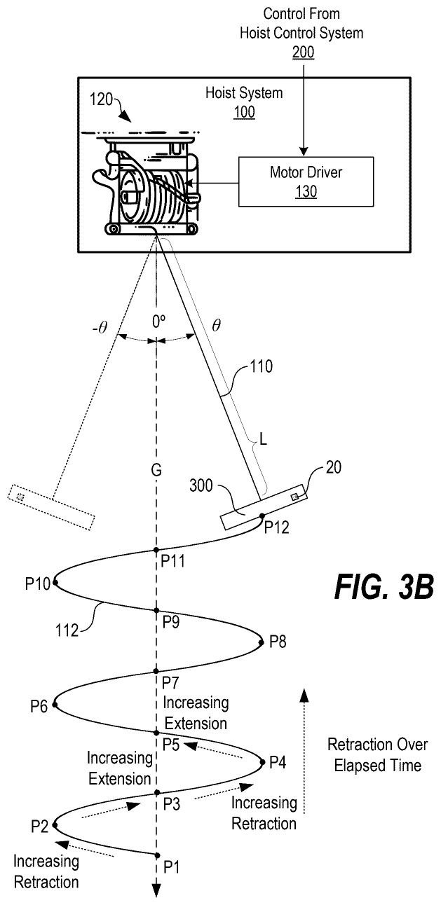

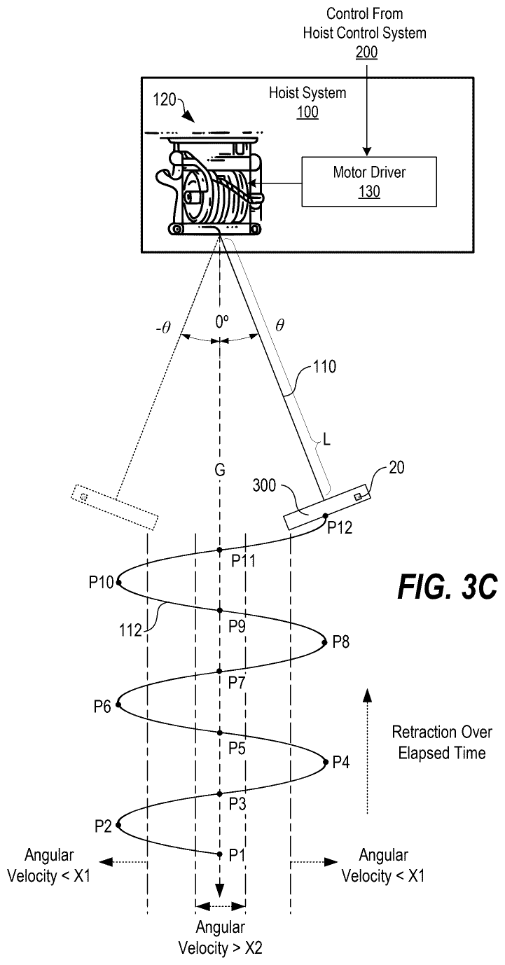

As another example shown in FIG. 3A, the hoist control system 200 can direct the motor controller 150 to increase the retraction rate of the hoist cable 110 as the velocity of the payload 300 decreases, such as between the points P1 and P2 along the trajectory 112. The processor 220 can also direct the motor controller 150 to decrease the rate of retraction of the hoist cable 110 as the velocity of the payload 300 increases, such as between the points P2 and P3 along the trajectory 112. Similarly, the processor 220 can direct the motor controller 150 to increase the retraction rate of the hoist cable 110 between the points P3 and P4, and the processor 220 can also direct the motor controller 150 to decrease the retraction rate of the hoist cable 110 between the points P4 and P5.

The processor 220 of the hoist control system 200 can increase the rate of retraction of the hoist cable 110 in a manner that is linearly proportional to a decrease in the velocity of the payload 300 along the trajectory 112 in another example. The processor 220 can also decrease the rate of retraction of the hoist cable 110 in a manner that is linearly proportional to an increase in the velocity of the payload 300 along the trajectory 112. In other words, the processor 220 can retract the hoist cable 110 to a greater extent when the velocity of the payload 300 is slower and retract the hoist cable 110 to a lesser extent when the velocity of the payload 300 is faster.

In other cases, the processor 220 can increase the rate of retraction of the hoist cable 110 in a manner that is not linearly proportional to a decrease in the velocity of the payload 300 along the trajectory 112. The processor 220 can also decrease the rate of retraction of the hoist cable 110 in a manner that is not linearly proportional to an increase in the velocity of the payload 300 along the trajectory 112. For example, the processor 220 can retract the hoist cable 110 at a rate that is a non-linear function or factor of the velocity of the payload 300 over time. In this case, the rate of retraction of the hoist cable 110 can increase more significantly as the speed of the payload reduces over time. Similarly, the rate of retraction of the hoist cable 110 can decrease more significantly as the speed of the payload increases over time.

In another example, the processor 220 can both retract the hoist cable 110 and also extend the hoist cable 110 over the trajectory 112 of the payload. In that context, FIG. 3B illustrates the trajectory 112 of the payload 300 with periods of retraction and extension. As shown in FIG. 3B, the processor 220 can increase the rate of retraction of the hoist cable 110 in a manner that is linearly or non-linearly proportional to a decrease in the velocity of the payload 300 along parts of the trajectory 112, such as between P1 and P2, between P3 and P4, between P5 and P6, etc. The processor 220 can also increase the rate of extension of the hoist cable 110 in a manner that is linearly or non-linearly proportional to an increase in the velocity of the payload 300 along other parts of the trajectory 112, such as between P3 and P3, between P4 and P5, between P6 and P7, etc. Thus, the processor 220 can both retract the hoist cable 110 and also extend the hoist cable 110 over the trajectory 112. However, despite the periods of extension, the processor 220 generally controls the hoist system 100 to retract (reel in) the payload 300 more than it extends (reel out) the payload 300. That is, the average or overall rate of retraction is greater than the overall rate of extension of the hoist cable 110, thereby leading to a medical evacuation rescue that leads to retrieval of the patient into the helicopter.

In other cases, it is not necessary to have the average or overall rate of retraction to be greater than the overall rate of extension of the hoist cable 110. In other words, the reel in and reel out can be the same or have the same length, resulting in a time average constant length of the hoist cable 110. This can still result in decreased amplitude of oscillation of the swing, leading to a stabilized payload 300. After stabilizing the payload 300 with 5 degree angle theta (or less), the hoist cable 110 can be reeled in to retrieve the patient into the helicopter 10 for a successful medical evacuation rescue. Otherwise the reel in does not need to take place and instead the helicopter 10 can fly away with the payload 300 not swinging (with theta close to zero) at some constant length of the hoist cable 110 below the helicopter.

FIG. 3C illustrates another example trajectory 112 of the payload 300 with periods of retraction and extension. As shown in FIG. 3C, the processor 220 can retract the hoist cable 110 when the angular velocity of the payload 300 is less than a first predetermined threshold of angular velocity “X1,” and the processor 220 can extend the hoist cable 110 when the angular velocity of the payload 300 is greater than a second predetermined threshold of angular velocity “X2”. In another example, the processor 220 can retract the hoist cable 110 only when the angular velocity of the payload 300 is less than the X1 threshold of angular velocity, without any extension of the hoist cable 110.

FIG. 3C also shows an example of when the angular velocity of the payload 300 is less than X1 with respect to certain portions or regions of the trajectory 112 and when the angle of the payload is greater than some prespecified threshold. FIG. 3C also shows an example of when the angular velocity of the payload 300 is greater than X2 with respect to certain portions or regions of the trajectory 112. The X1 and X2 angular velocity thresholds can be the same as each other or different than each other. However, despite the periods of extension, the processor 220 generally controls the hoist system 100 to retract the payload 300 more than it extends the payload 300. That is, the average or overall rate of retraction is greater than the overall rate of extension of the hoist cable 110 but does not have to be greater overall in order to stabilize the payload 300, as discussed above.

As part of the stabilized retraction control algorithm, the processor 220 can be configured to maintain the maximum positive and negative angles θ to under a threshold angle value, to maintain the maximum velocity of the payload 300 to under a threshold velocity, and to maintain other target constraints.

As part of a stabilized extension control algorithm, the processor 220 of the hoist control system 200 can direct the motor controller 150 to increase the extension rate of the hoist cable 110 as the angular velocity of the payload 300 increases. The processor 220 can also direct the motor controller 150 to decrease the rate of extension of the hoist cable 110 as the angular velocity of the payload 300 decreases. Referring to FIG. 3A as an example, the processor 220 can direct the motor controller 150 to increase the extension rate of the hoist cable 110 as the payload 300 approaches the higher angular velocity points P1, P3, P5, etc., and to decrease (or stop) the rate of extension as the payload approaches the lower angular velocity points P2, P4, P6, etc. In this way, the extension of the hoist cable 110 can predominately occur when the payload 300 is experiencing higher angular velocity, and the extension of the length L of the hoist cable 110 at those times produces a decrease in the magnitude of the next oscillation.

In the manual extension and manual retraction modes of operation, the processor 220 of the hoist control system 200 can direct the motor controller 150 to extend or retract the hoist cable 110 without reference to the velocity or angular velocity of the payload 300 based on input received through the user interface 240.

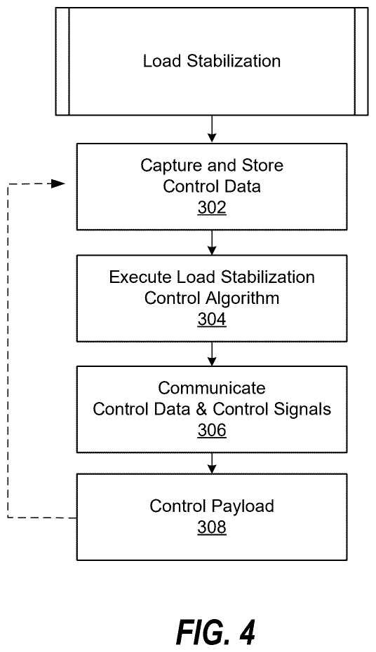

FIG. 4 illustrates an example hoist control method according to various examples described herein. As an example, one or more of (or some combination of) the hoist system 100, the hoist control system 200, and the IMCU 20 can perform the hoist control method shown in FIG. 4. The hoist control method shown in FIG. 4 can also be performed by other systems, however, such as in hoist control systems of helicopters, air ballons, drones, airplanes, airborne vehicles, cranes, and other maneuvering and lifting systems. Thus, while the examples below reference the helicopter 10 and FIGS. 1, 2, and 3A-3C, the method shown in FIG. 4 can be implemented in other systems. The method shown in FIG. 4 is not exhaustively illustrated and can include other steps in some cases. The method can also omit one or more of the steps shown, and the steps can be performed concurrently, rearranged, or performed in alternative sequences as compared to that shown in some cases. The process shown in FIG. 2 can continue over time, and the steps shown in FIG. 2 can repeat over time.

At step 302, the process includes capturing and storing control data. The control data can include command and control signals, user control data, inertial measurement data, and other types of data. The control data can be captured and stored in any suitable format and using any suitable communications protocols. As a more particular example, step 302 can include the IMCU 20 capturing inertial measurement data related to the motion of the payload 300 and storing it in the memory 310. The inertial measurement data can be captured using the IMU 340, for example, and include triaxial measurement data, including but not limited to spatial position, velocity, acceleration, pitch, yaw, roll, time rate of change of pitch, time rate of change of yaw, time rate of change of roll, and other related motion data of the payload 300 over time. Step 302 can also include the IMCU 20 capturing user control data from one or more individuals using the user interface 350, including possibly from an individual being rescued as part of the payload 300. The inertial measurement data and user control data can be stored in the memory 310 as part of step 302.

Step 302 can also include the hoist control system 200 capturing user control data from one or more individuals using the user interface 240, such as from a member of the crew on the helicopter 10. Step 302 can also include the hoist control system 200 capturing inertial measurement data using an IMU of the host control system 200. The inertial measurement data and user control data can be stored in the memory 210 as part of step 302.

At step 304, the process includes executing a load stabilization control algorithm. Executing the load stabilization control algorithm at step 304 can include one or more of executing the stabilized retraction control algorithm, executing the stabilized extension control algorithm, executing the manual retraction algorithm, or executing the manual extension algorithm, as those algorithms are described herein. Step 304 can be performed by the IMCU 20, the processor 220, or by a combination of both the IMCU 20 and the processor 220. Step 304 can include processing the control data that was captured and stored at step 302, as part of the execution of the load stabilization control algorithm.

One objective of the execution of the load stabilization control algorithm at step 304 is to generate the command and control signals for the hoist system 100. The “T” and “F” control signals described herein are examples of such command and control signals, where “T” is a command to reel in or up the hoist cable 110 and “F” is a command to maintain the length of the hoist cable 110. The execution of the load stabilization control algorithm at step 304 can generate the “T” and “F” control signals based on the triaxial measurement data stored at step 302. The command and control signals can be provided to the motor controller 250 or the hoist system 250 in later steps.

The execution of the load stabilization control algorithm can generate command and control signals consistent with the stabilized retraction, stabilized extension, manual retraction, and manual extension algorithms or operations described above in connection with FIGS. 2 and 3A-3D, as examples. Thus, step 304 can result in the generation of one or more “T” and “F” control signals that result in the load stability operations described in FIGS. 2 and 3A-3D, based on the triaxial measurement data stored at step 302. The “T” and “F” control signals can include a “T” command to reel in or up the hoist cable 110 and “F” is a command to maintain the length of the hoist cable 110. An example “T” command can include command or control information that specifies a particular retraction or reel in speed to be used, along with a frame or time period over which the speed is to be used. The “T” command can also include a series of retraction commands or instructions, such as a first retraction speed for a first frame of time, a second retraction speed for a second frame of time, a third retraction speed for a third frame of time, and so on, for any number of frames or time periods.

An example “F” command can include command or control information to specify a frame or period of time over which the length of the hoist cable 110 should be maintained (i.e., neither reeled in nor reeled out). Another example “F” command can include command or control information that specifies a particular extension or reel out speed to be used, along with a frame or time period over which the speed is to be used. The “F” command can also include a series of extension commands or instructions, such as a first extension speed for a first frame of time, a second extension speed for a second frame of time, a third extension speed for a third frame of time, and so on, for any number of frames or time periods. In still other cases, a single command can also include a combination of retraction speeds, extension speeds, and associated time frames for each retraction and extension speed. The command and control signals can be provided to the motor controller 250 or the hoist system 250 in later steps. The execution of the load stabilization control algorithm at step 304 can also include execution of the algorithms described in Appendix A and Appendix B of the '497 Application.

At step 306, the process includes communicating the control data stored at step 302, communicating the command and control signals generated at step 304, and communicating any other data between the hoist control system 200 and the IMCU 20. The hoist control system 200 and the IMCU 20 can communicate data between each other by wireless or wired communications at step 306 using the communications modules 230 and 330. The control data of step 302, the command and control signals of step 304, and other data can be exchanged between the hoist control system 200 and the IMCU 20 at step 306. The exchanged data can also be stored in memory as part of step 306. Step 306 can also be considered an ongoing or background process step, as the data communication between the hoist control system 200 and the IMCU 20 can be continuous among and concurrent with other steps.

At step 308, the process includes controlling a payload based on the command and control signals generated at step 304. For example, step 304 can include the processor 220 directing the motor controller 250 based on the command and control signals generated at step 304. Step 308 can thus result in controlling the reel in and reel out of the payload 300 by the hoist system 100 according to the load stability operations described in FIGS. 2 and 3A-3D.

The functional features of the hoist control system 200, as described herein, can be embodied in the form of hardware, as software components that are executable by hardware, or as a combination of software and hardware. If embodied as hardware, the components described herein can be implemented as a circuit or state machine that employs any suitable hardware technology. The hardware technology can include, for example, one or more microprocessors, printed circuit boards (PCB), discrete logic circuits having logic gates for implementing various logic functions upon an application of one or more data signals, application specific integrated circuits (ASICs) having appropriate logic gates, and/or programmable logic devices (e.g., field-programmable gate array (FPGAs), and complex programmable logic devices (CPLDs)), including but not limited to buttons, toggle switches, other types of switches.

Also, one or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as magnetic, optical, semiconductor, and/or other suitable media. Examples of a suitable computer-readable media include, but are not limited to, sim cards, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Further, any logic or applications described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices. Additionally, terms such as “application,” “service,” “system,” “engine,” “module,” “block”, “unit”, and so on can be used interchangeably and are not intended to be limiting.

The above-described examples of the present disclosure are merely possible examples of implementations set forth for a clear understanding of the principles of the disclosure. Many variations and modifications can be made without departing substantially from the spirit and principles of the disclosure. All such modifications and variations are intended to be included herein within the scope of this disclosure and protected by the following claims.

Therefore, the following is claimed:

1. A load stabilization system, comprising:
a hoist system comprising a hoist cable;
an inertial measurement and control unit located with a payload of the hoist system; and
a hoist controller, the hoist controller comprising:
a communications module configured to receive data from the inertial measurement and control unit; and
a processor configured to direct the hoist system to reel in the hoist cable during at least one period of time based on the data from the inertial measurement and control unit.

2. The load stabilization system according to claim 1, wherein the processor is further configured, based on the data from the inertial measurement and control unit, to:
reel in the hoist cable during a first period of time;
not reel up the hoist cable during a second period of time; and
reel out the hoist cable during a third period of time.

3. The load stabilization system according to claim 1, wherein the processor is further configured, based on the data from the inertial measurement and control unit, to:
reel in the hoist cable during a first period of time when a velocity of the payload is slower and an angle of the payload is higher than a threshold value; and
not reel in the hoist cable during a second period of time when the velocity of the payload is faster and the angle of the payload is lower than the threshold value; and
reel out the hoist cable during a third period of time when the velocity of the payload is faster and an angle of the payload is lower than another threshold value.

4. The load stabilization system according to claim 1, wherein the processor is further configured to reel out the hoist cable during at least one other period of time based on the data from the inertial measurement and control unit.

5. The load stabilization system according to claim 1, wherein the processor is further configured, based on the data from the inertial measurement and control unit, to:
increase a reel in rate of the hoist cable as a velocity of the payload decreases; and
decrease the reel in rate of the hoist cable as the velocity of the payload increases.

6. The load stabilization system according to claim 1, wherein the processor is further configured, based on the data from the inertial measurement and control unit, to:
linearly increase a reel in rate of the hoist cable as a velocity of the payload decreases; and
linearly decrease the reel in rate of the hoist cable as the velocity of the payload increases.

7. The load stabilization system according to claim 1, wherein the processor is further configured, based on the data from the inertial measurement and control unit, to:
non-linearly increase a reel in rate of the hoist cable as a velocity of the payload decreases; and
non-linearly decrease the reel in rate of the hoist cable as the velocity of the payload increases.

8. The load stabilization system according to claim 1, wherein the inertial measurement and control unit is configured to issue “T” or “F” command signals to the hoist controller over time as the payload moves along a trajectory.

9. The load stabilization system according to claim 8, wherein:
the “T” command signal directs the hoist system to reel in the hoist cable; and
the “F” command signal directs the hoist system not to reel in the hoist cable.

10. The load stabilization system according to claim 1, wherein the inertial measurement and control unit is configured to wirelessly communicate the data to the hoist controller.

11. The load stabilization system according to claim 1, wherein the load stabilization system is configured to operate in at least one of manual extension, manual retraction, stabilized extension, and stabilized retraction modes of operation.

12. The load stabilization system according to claim 1, wherein the communications module is further configured to send data, including acknowledgment data, to the inertial measurement and control unit.

13. The load stabilization system according to claim 1, wherein the inertial measurement and control unit is configured to receive data from and send data to the communications module of the hoist controller.

14. A load stabilization system, comprising:
a hoist system comprising a hoist cable; and
an inertial measurement and control unit located with a payload at an end of the hoist cable, the inertial measurement and control unit being configured to direct the hoist system to reel in the hoist cable as a velocity of the payload decreases.

15. The load stabilization system according to claim 14, wherein the inertial measurement and control unit is further configured to:
reel in the hoist cable during a first period of time; and
not reel in the hoist cable during a second period of time.

16. The load stabilization system according to claim 14, wherein the inertial measurement and control unit is further configured to:
reel in the hoist cable during a first period of time when the velocity of the payload is slower and an angle of the payload is higher than a threshold value; and
not reel in the hoist cable during a second period of time when the velocity of the payload is faster and the angle of the payload is lower than the threshold value.

17. The load stabilization system according to claim 14, wherein the inertial measurement and control unit is further configured to:
increase a reel in rate of the hoist cable as a velocity of the payload decreases; and
decrease the reel in rate of the hoist cable as the velocity of the payload increases.

18. The load stabilization system according to any one of claim 14, further comprising a user interface for selection among manual extension, manual retraction, stabilized extension, and stabilized retraction modes.

19. The load stabilization system according to claim 14, wherein the inertial measurement and control unit further comprises a user interface for use by an individual as part of the payload, the user interface comprising an interface selection among manual and stabilized modes.

20. The load stabilization system according to claim 14, wherein the inertial measurement and control unit comprises an inertial measurement unit, and the inertial measurement unit is configured to capture triaxial measurement data of the payload.
